(19) United States
(12) Patent Application Publication
(10) Pub. No.: US 2018/0348974 A1
(43) Pub. Date: Dec. 6, 2018

(54) SYSTEM FOR TRAVEL MANAGEMENT

(71) Applicant: Anatoliy Pisarenko, Rancho Cordova, CA (US)

(72) Inventor: Anatoliy Pisarenko, Rancho Cordova, CA (US)

(21) Appl. No.: 15/611,972

(22) Filed: Jun. 2, 2017

(51) Int. Cl. G06F 3/0483; G06F 3/0482

(52) U.S. Cl. CPC G06F 3/0483; G06F 3/0482

(57) ABSTRACT

A system for travel management that includes: a smartphone; a software application, where the software application includes instructions for destination and timing management; global positioning associated with the software application; and at least two display tabs wherein each display tab is associated with a destination and the at least two display tabs are visible on the smartphone where each display tab provides a travel time for the destination. The display tabs may include at least one frequent destination tab and in one exemplary embodiment, a first frequent destination tab is associated with a user's home address and a second frequent destination tab is associated with a user's work address. The system preferably aligns the at least two display tabs in a sequence of desired travel and consistently updates the travel time associated with each display tab.

### BACKGROUND OF THE INVENTION

### Field of Invention

The present invention relates to a system for implementing travel management through a smart phone.

### Description of Related Art

It is well known smart phones are used for various daily tasks beyond simple telephonic calls. In addition to calls, data is exchanged from phone to phone through various platforms such as individual texts, social media platforms and other interactive applications available through a smart phone. A plethora of information is accessible to the smart phone such as weather, news, travel, maps and directions. Individuals frequently use travel directions when navigating through traffic daily. This feature is very suitable for travelers, who may be in an unfamiliar city. Further it is helpful for individuals in their home towns and metropolitan areas. Many times, individuals make several stops or have several destinations on any day. Although each destination could be easily tracked or cued individually there lacks any applications that will allow for consistent tracking of a series of destinations for constant display by a user on a smart phone. As a result, it is the objective of the present invention to aid in travel management for several destinations that remain displayed on a display screen on a smart phone.

### SUMMARY OF THE INVENTION

The present invention relates to a system for travel management that includes: a smartphone; a software application, where the software application includes instructions for destination and timing management; global positioning associated with the software application; and at least two display tabs wherein each display tab is associated with a destination and the at least two display tabs are visible on the smartphone where each display tab provides a travel time for the destination. The display tabs may include at least one frequent destination tab and in one exemplary embodiment, a first frequent destination tab is associated with a user's home address and a second frequent destination tab is associated with a user's work address. The system preferably aligns the at least two display tabs in a sequence of desired travel and consistently updates the travel time associated with each display tab.

### BRIEF DESCRIPTION OF DRAWINGS

FIG. 1 depicts an overview of the travel system in accordance with the present invention.

### DETAILED DESCRIPTION

The present invention relates to a system for travel management that is integrated within a smart phone through a software application. The software application is associated with global positioning software installed on the smart phone. Through the use of the software of the present invention, display tabs are provided on the screen of the smart phone. Each display tab is associated with a destination and displays a travel time associated with a destination. The travel times associated with each destination may be consistently updated as an individual travels throughout the course of the day. This system enables an individual to be constantly informed of the travel times for particular destinations that may be part of a desired route. Further, the display may also include frequent destinations such as a home address or work address of the user so that the user is informed of destination times immediately at the beginning and near the end of the work day.

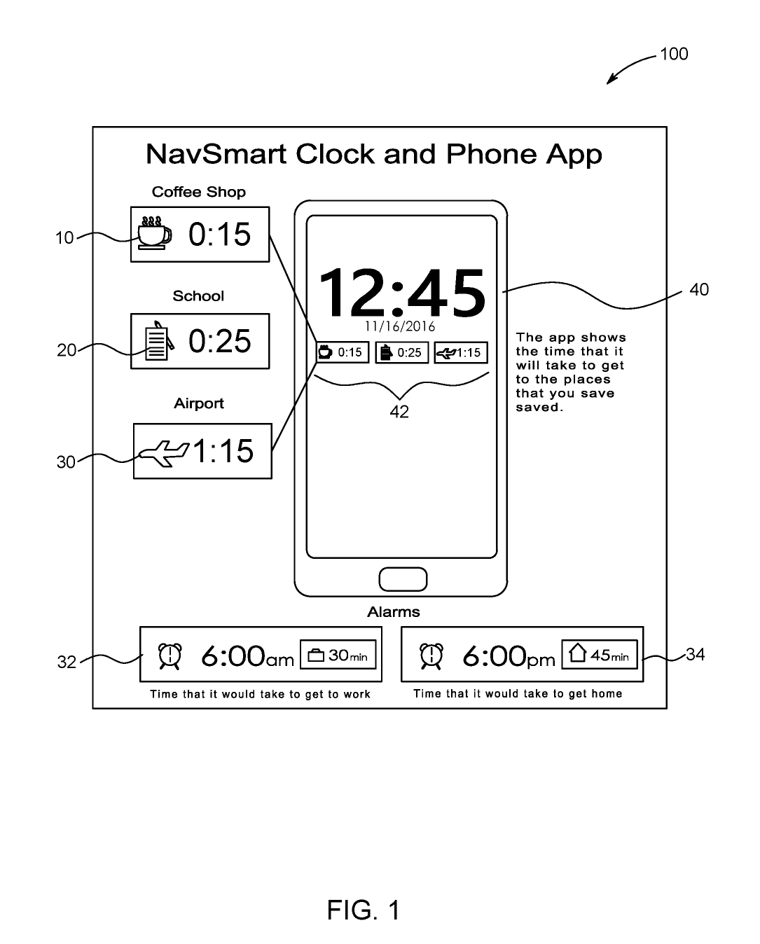

In reference to FIG. 1 an overview of the system for travel management 100 is displayed therein. This system for travel management 100 includes use of a smart phone 40 as shown with an exemplary display. In the display shown in FIG. 1, a current time is displayed in large graphics on the display. Also a date could be implemented in this display for the user's convenience. Principally shown in FIG. 1 are three destinations, a Destination A 10, Destination B 20 and Destination C 30. Travel time associated with each destination is also displayed. The travel times are produced through the use of the software application installed and integrated into the smart phone. The destinations may be entered by a user and therefore displayed for use by the user so a user can have destination times for multiple locations on display on the smart phone 40. Although three destinations are shown in this particular embodiment, less destinations may be shown such as two or even up to a multitude of destinations, such as five destinations may be shown. These destinations are constantly updated as a user travels to each location. Further, a destination may be deleted from the display once a user arrives at a destination and the remaining destinations are displayed with updated travel times based upon the positioning of the user.

The display on the smart phone 40 may also include common destinations such as a home address or a work address as shown in FIG. 1. Common Destination A 32 and Common Destination B 34 are shown, which could be associated with the user's work and home address. This provides constant information to the user of these common destinations so that a user is readily aware of timing for work arrival and timing for home arrival which are usually common destinations on each user's day. The present invention as a result provides another convenient and effective application to assist the users in daily activities.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system for travel management comprising:
a. a smartphone;
b. a software application, where the software application includes instructions for destination and timing management;
c. global positioning associated with the software application; and
d. at least two display tabs wherein each display tab is associated with a destination and the at least two display tabs are visible on the smartphone where each display tab provides a travel time for the destination.

2. The system according to claim 1, further including at least one frequent destination tab.

3. The system according to claim 2, where a first frequent destination tab is associated with a user's home address and a second frequent destination tab is associated with a user's work address

4. The system according to claim 1, where the system aligns the at least two display tabs in a sequence of desired travel.

5. The system according to claim 1, where the system consistently updates the travel time associated with each display tab.
